(19) United States
(12) Patent Application Publication
(10) Pub. No.: US 2008/0114822 A1
(43) Pub. Date: May 15, 2008

(54) Enhancement of extraction of film thickness from x-ray data

(76) Inventor: Benjamin David Poust, Los Angeles, CA (US)

Correspondence Address: PATTI, HEWITT & AREZINA LLC, ONE NORTH LASALLE STREET, 44TH FLOOR, CHICAGO, IL, 60602, US

(21) Appl. No.: 11/599,527

(22) Filed: Nov. 14, 2006

(51) Int. Cl. G06F 17/14

(52) U.S. Cl. 708/403

(57) ABSTRACT

A method embodiment of the present method and apparatus may comprise: transforming raw data into flattened data; taking a first derivative of the flattened data to produce derivate data; and applying a Fourier transform to the derivate data to produce transformed data. A system embodiment of the present method and apparatus may have: a recorder module for recording raw x-ray scatter data associated with a thickness of at least one film layer on a substrate; a transform module for transforming the raw x-ray scatter data into flattened data that is a sloping set of data, the transform module operatively coupled to the recorder module; a derivative module for applying a derivative to level off the sloping set of data to produce derivate data, the derivative module operatively coupled to the transform module; a Fourier module for applying a Fourier transform to the derivate data to produce transformed data, the Fourier module operatively coupled to the derivative module; and a display module for displaying the transformed data as a plot of intensity versus thickness of the at least one film layer, the display module operatively coupled to the Fourier module. The raw x-ray scatter data may be converted to converted raw x-ray scatter data with a predetermined conversion function. The raw x-ray scatter data may be in the form of intensity as a function of angle, and the converted raw x-ray scatter data being in the form of intensity as a function of reciprocal space coordinate.

### TECHNICAL FIELD

The invention relates generally to measuring the thickness of layers on substrates and, more specifically, the measurement of layers on substrates by transforming and displaying x-ray scatter data.

### BACKGROUND

The semiconductor industry has a continuing interest in measuring thin films formed on wafers. A number of metrology devices have been developed for making these measurements. Many of these devices rely on probing the sample with a beam of radiation having a wavelength in the visible and/or UV regions. These devices work quite well on many different types of films which are at least partially transparent at these wavelengths. Unfortunately, these devices are not effective for investigating opaque and metal films, since opaque and metal films (such as copper) do not transmit either UV or visible radiation.

There have recently been developed some techniques using wavelengths in the X-ray regime. These X-ray reflectometry techniques (XRR) have several advantages over techniques using visible light. One such advantage is that XRR makes it possible to measure the thickness of ultra-thin films whose thicknesses are on the order of 30 angstroms or less. Visible light is not suitable for the study of such ultra-thin films using interference patterns because of its wavelength. However, an XRR system may preferably use radiation at wavelengths of about 1.5 angstroms, which radiation creates suitable interference patterns even when probing such ultra-thin films. In addition, XRR may suitably be used where the film is composed of a material that is opaque to light, such as a metal or metal compound. Another possible application for XRR methods might be as an in-situ monitor where only a grazing angle beam of radiation can be used to monitor a sample in a process chamber. Finally, XRR may suitably be used to measure the density and thickness of films composed of materials that have a low dielectric constant and a correspondingly low index of refraction, such as certain polymers, carbon fluoride compounds, and aerogels.

However, smoothly varying intensity fluctuations in x-ray scatter data limit film thickness analyses based on Fourier transforms of x-ray reflectivity and high resolution x-ray diffraction scans. The problem lies in suppressing the smoothly varying part while preserving and/or amplifying the rapidly varying part(s).

Thus, there is a need in the art for an improved measurement of layers on substrates by transforming and displaying x-ray scatter data.

### SUMMARY

One embodiment of the present method and apparatus encompasses an apparatus. The apparatus may be a programmable computer having: a record module for recording raw x-ray scatter data associated with a thickness of at least one film layer on a substrate; a transform module for transforming the raw x-ray scatter data into flattened data; a derivative module for taking a first derivative of the flattened data to produce derivate data; a Fourier module for applying a Fourier transform to the derivate data to produce transformed data; and a display module for displaying the transformed data as a plot of intensity versus thickness of the at least one film layer.

Another embodiment of the present method and apparatus encompasses a method. The method may comprise: transforming raw data into flattened data; taking a first derivative of the flattened data to produce derivate data; and applying a Fourier transform to the derivate data to produce transformed data.

Another embodiment of the present method and apparatus encompasses a system. The system may have: a recorder module for recording raw x-ray scatter data associated with a thickness of at least one film layer on a substrate; a transform module for transforming the raw x-ray scatter data into flattened data that is a sloping set of data, the transform module operatively coupled to the recorder module; a derivative module for applying a derivative to level off the sloping set of data to produce derivate data, the derivative module operatively coupled to the transform module; a Fourier module for applying a Fourier transform to the derivate data to produce transformed data, the Fourier module operatively coupled to the derivative module; and a display module for displaying the transformed data as a plot of intensity versus thickness of the at least one film layer, the display module operatively coupled to the Fourier module.

### DESCRIPTION OF THE DRAWINGS

The features of the embodiments of the present method and apparatus are set forth with particularity in the appended claims. These embodiments may best be understood by reference to the following description taken in conjunction with the accompanying drawings, in the several figures of which like reference numerals identify like elements, and in which:

FIG. 1 is a reciprocal space illustration of one type of substrate having a layer on a surface thereof;

FIG. 2 is a graph of intensity versus scatter angle of the layer on the substrate of FIG. 1;

FIG. 3 is an illustration of the laminar structure of another type of substrate having two different layers on a surface thereof;

FIG. 4 is a graph of intensity versus scatter angle of the layer on the substrate of FIG. 3;

FIG. 5 is another graph of intensity versus scatter angle of the layer on the substrate of FIG. 3;

FIG. 6 is another reciprocal space illustration of one type of substrate having a layer on a surface thereof;

FIG. 7 illustrates the analogous relationship between the time and frequency domains in a standard Fourier transform, and the reciprocal and real space domains associated with x-ray scatter oscillations for a layer on a substrate;

FIG. 8 depicts a sine wave and

FIG. 9 depicts a discrete Fourier transform of the FIG. 8 wave;

FIG. 10 depicts a truncated sine wave and

FIG. 11 depicts a discrete Fourier transform of the FIG. 10 wave;

FIG. 12 depicts a square wave pulse and

FIG. 13 depicts a discrete Fourier transform of the FIG. 12 wave;

FIG. 14 depicts an offset sine wave and

FIG. 15 depicts a discrete Fourier transform of the FIG. 14 wave;

FIG. 16 is a graph of intensity versus reciprocal scattering vector, or reciprocal space coordinate, Q_{z}, of a layer on a substrate, and

FIG. 17 depicts a discrete Fourier transform of the FIG. 16 wave;

FIG. 18 is a graph of intensity versus scatter angle of a layer on a substrate, and

FIG. 19 depicts a discrete Fourier transform of the FIG. 18 wave;

FIG. 20 is a graph depicting specular and off-specular scans, and

FIG. 21 depicts the results of taking a fast Fourier transform thereof;

FIG. 22 is another graph depicting specular and off-specular scans, and

FIG. 23 depicts the results of taking a fast Fourier transform thereof;

FIG. 24 is a graph depicting logarithmic compression, and

FIG. 25 depicts the results of taking a fast Fourier transform thereof following subtraction of a semi-local intensity average;

FIG. 26 is a graph depicting logarithmic compression and the semi-local intensity average;

FIG. 27 is a graph of intensity versus two times the angle of incidence;

FIG. 28 is a graph of the intensity of FIG. 27 multiplied by Q_{z}⁴ versus Q_{z}⁴;

FIG. 29 depicts a sine wave and

FIG. 30 depicts the results of taking a discrete Fourier transform of the FIG. 29 wave;

FIG. 31 depicts a derivative of the sine wave and

FIG. 32 depicts the results of taking a discrete Fourier transform of the FIG. 31 wave;

FIG. 33 depicts an offset sine wave and

FIG. 34 depicts the results of taking a discrete Fourier transform of the FIG. 33 wave;

FIG. 35 depicts a derivative of the FIG. 33 offset sine wave and

FIG. 36 depicts the results of taking a discrete Fourier transform of the FIG. 35 wave;

FIG. 37 depicts the derivative of a sloping sine wave and

FIG. 38 depicts the results of taking a discrete Fourier transform of the FIG. 37 wave;

FIG. 39 depicts a derivative of the log of the FIG. 37 wave and

FIG. 40 depicts the results of taking a discrete Fourier transform of the FIG. 39 wave;

FIG. 41 depicts measurement of a layer on a substrate using X-rays according to an embodiment according to the present method and apparatus;

FIG. 42 depicts an embodiment according to the present method and apparatus;

FIG. 43 depicts a conversion of raw x-ray scatter data, and

FIG. 44 depicts the results of taking a discrete Fourier transform of the FIG. 43 wave;

FIG. 45 depicts a flattening of the data, and

FIG. 46 depicts the results of taking a discrete Fourier transform of the FIG. 45 wave;

FIG. 47 depicts another flattening of the data, and

FIG. 48 depicts the results of taking a discrete Fourier transform of the FIG. 47 wave;

FIG. 49 depicts a leveling of a slope of the data, and

FIG. 50 depicts the results of taking a discrete Fourier transform of the FIG. 49 wave;

FIG. 51 depicts a method embodiment according to the present method and apparatus;

FIG. 52 depicts another method embodiment according to the present method and apparatus;

FIG. 53 depicts a software embodiment according to the present method and apparatus; and

FIG. 54 depicts a system embodiment according to the present method and apparatus.

### DETAILED DESCRIPTION

In general, simultaneous compression of x-ray scatter varying slowly with scattering angle and enhancement of rapidly varying scatter intensity may be accomplished by taking the derivative of the scattered intensity with respect to the scattering angle (or, equivalently, the derivative with respect to the reciprocal space coordinate normal to the film surface, Q_{z}). Further enhancement may be gained, for example, by taking the derivative of data that has been compressed logarithmically.

There is a growing need for experimental techniques capable of obtaining precise values of layer thickness of thin films in, for example, modern semiconductor processing that relies on successive deposition of thin layers of metals and dielectrics. The active region of most semiconductor lasers contains a number of quantum wells and thin structures. The mirrors of vertical cavity surface lasers rely on alternating quarter wavelength layers of two materials whose thickness must be controlled with precision. Specular x-ray reflectometry, a nondestructive technique capable of subnanometer thickness resolution, is commonly used in the study and characterization of individual layers and multilayer structures. In particular, given reasonably flat interfaces, the layer thickness is the parameter that determines the period of interference fringes present when the reflected intensity is measured as a function of the angle of incidence.

X-ray scatter data typically consists of x-ray intensity (counts per second) versus angle, which is related in a straight-forward way to reciprocal space coordinates. According to embodiments of the present method and apparatus, transformed x-ray scatter data may consist of intensity versus thickness. A scan showing thickness interference fringes is thus transformed into a scan showing a peak, or peaks, located at the thickness(es) corresponding to the interference fringe spacing(s). This enables easy and reliable automatic extraction of film thickness from x-ray scatter data.

Two main approaches to suppressing the smoothly varying part(s) of x-ray reflectivity scans are known: (1) subtraction of an off-specular scan (S, Raghavan G, and Sanyal M K, Journal of Applied Physics, volume 85, p. 7135 (1999)), and (2) multiplication of the intensity by the surface normal reciprocal space coordinate, Q_{z}, raised to the power of four (Durand 0, Thin Solid Films, volume 450, p. 51 (2004)).

A third known approach is based around averaging the data heavily, and then subtracting the averaged data from the original data (Grave de Peralta L and Temkin H, J. Appl. Phys., volume 93, p. 1974 (2003)). It is applicable to both x-ray reflectivity scans and to high resolution x-ray diffraction scans.

In general, Fourier transform based extraction of film thickness from x-ray scatter data is advantageous in that it circumvents the need for labor intensive and time consuming physical modeling of the data in order to extract film thickness. As discussed above, however, the nature of x-ray scatter data imposes severe limitations on the applicability of Fourier analysis. Embodiments of the present method and apparatus greatly extend the utility of Fourier analysis to specimens exhibiting extremely weak thickness interference fringes due to, for example: similar film and substrate indices of refraction, extremely thin films, rough films, etc. These embodiments succeed in producing useful Fourier transforms where known approaches are grossly ineffective.

Known techniques for measuring the thickness of layers on substrates utilize scattering of x-rays either in grazing-incidence reflectivity measurements or in diffraction measurements to give information about thin layers. However, it is not easy to apply Fourier transforms to data derived from this technique.

The notation 224 refers to the 224 reflection, which is a set of diffracting planes in the crystal. In reflectivity, however, one does not obtain diffraction from lattice planes in the crystal, one really only obtains fringes from the interfaces of the layer with the air above and the substrate below. This is referred to as the 000 reflection, even though there are no diffracting planes. In both reflectivity and diffraction measurements, when the scattered intensity is plotted against the surface normal reciprocal space coordinate, Q_{z}, the fringes show up with a regular spacing corresponding to a layer thickness.

Thickness fringes modulate a streak of scattered intensity near a given reciprocal lattice point (RLP) associated with truncation of the crystal. This truncation streak, or truncation rod, is due to the fact that the crystal is not infinitely thick. Because it is not infinitely thick in real space, it does not yield diffraction in infinitesimally small points in reciprocal space.

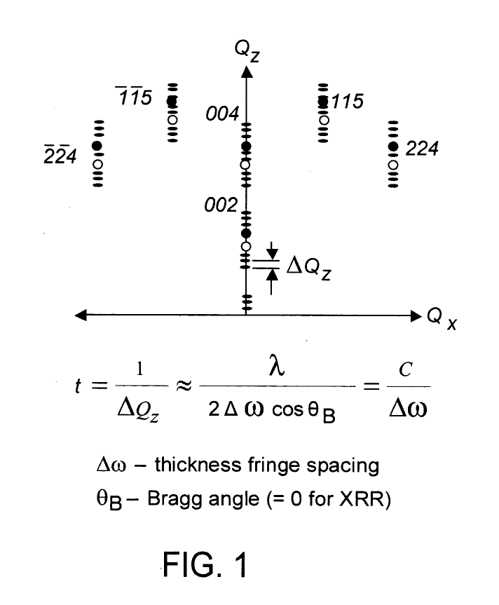

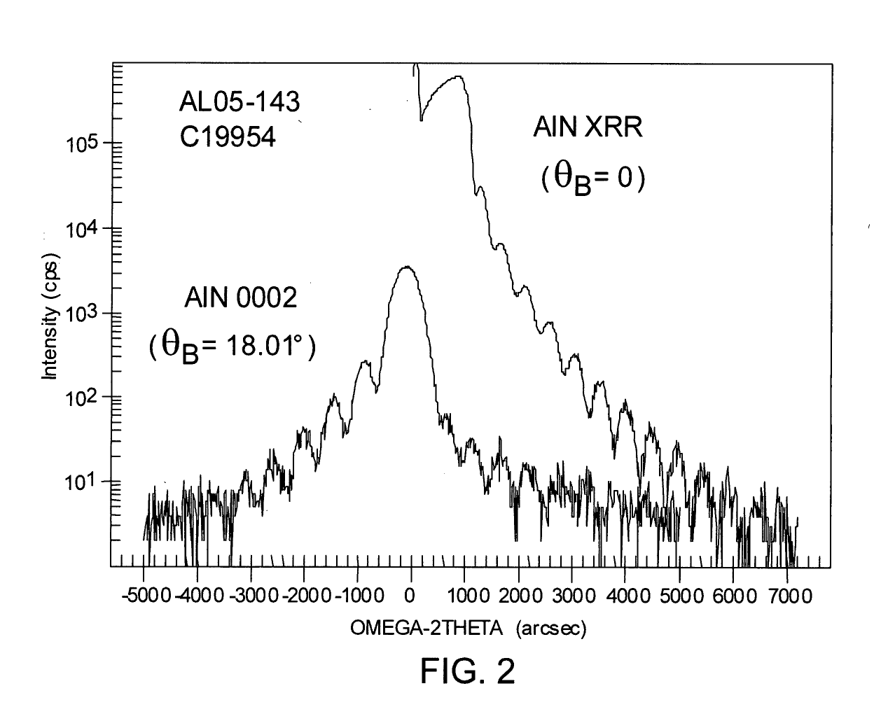

FIG. 2 is a graph of intensity versus scatter angle of the layer on the substrate of FIG. 1 and shows both a 0000 reflectivity measurement, and a 0002 diffraction measurement. So the truncation rod is basically all the intensity away from the maximum scattered or diffracted intensity. For a thicker crystal this will become narrower and sharper. With a thinner crystal it broadens out. This FIG. 2 graph depicts a fairly thin crystal. The truncation rod is that intensity spread due to the finite size of the crystal.

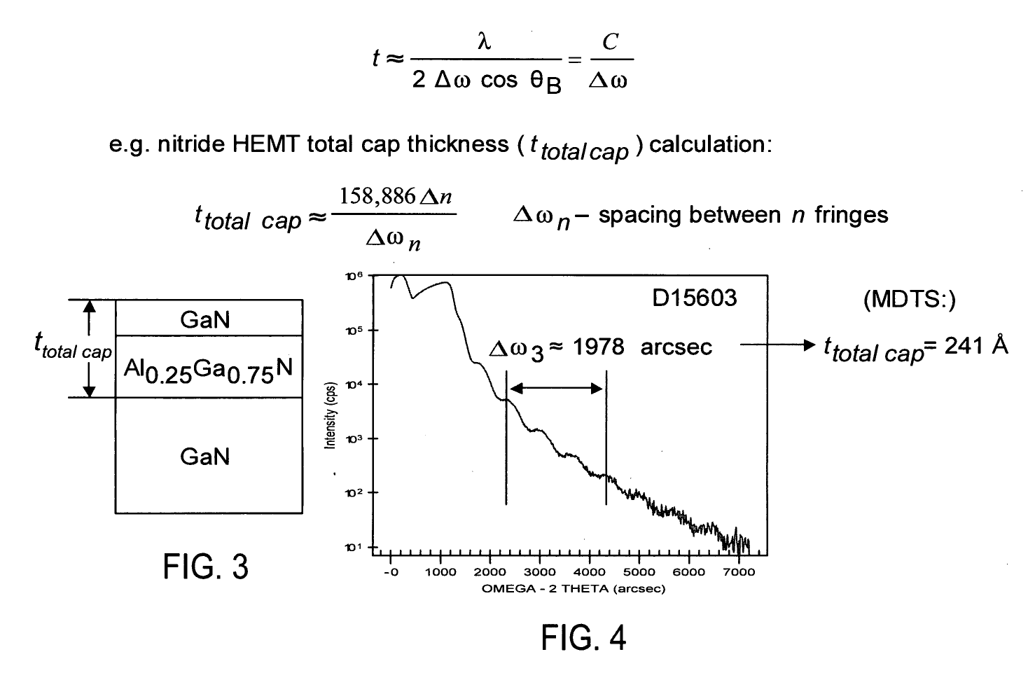

FIG. 3 is an illustration of the laminar structure of another type of substrate having two layers on a surface thereof. FIG. 4 is a graph of intensity versus scatter angle of the layers on the substrate of FIG. 3. In FIG. 4 is shown three fringes corresponding to 1978 arc seconds of splitting. Using this in the equation yields the thickness, t. This known approach does not use Fourier analysis

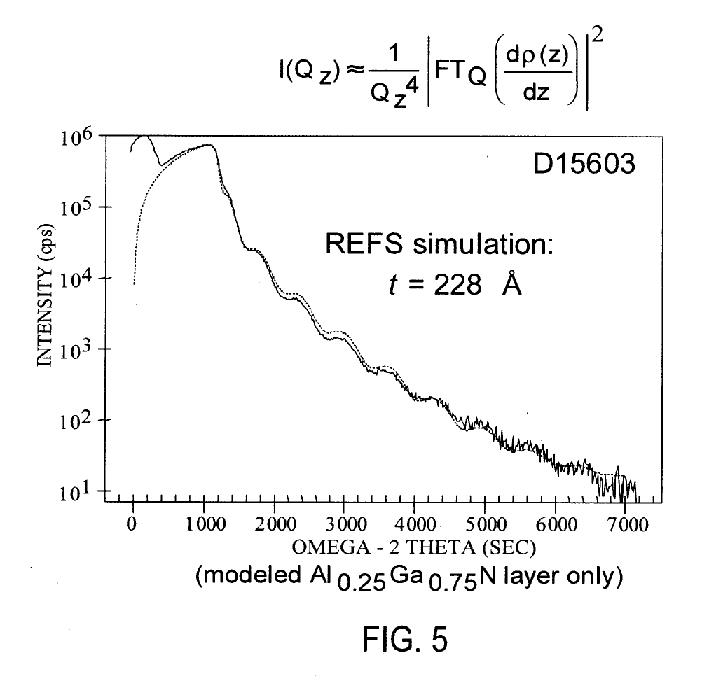

FIG. 5 is another graph of intensity versus scattering angle of the layer on the substrate of FIG. 3 showing a traditional approach to extracting film thickness. In this graph is shown the best-fit curve calculated using the dynamical theory. The thickness, t, is assumed to be that of the best-fit model. This known approach does not use Fourier analysis.

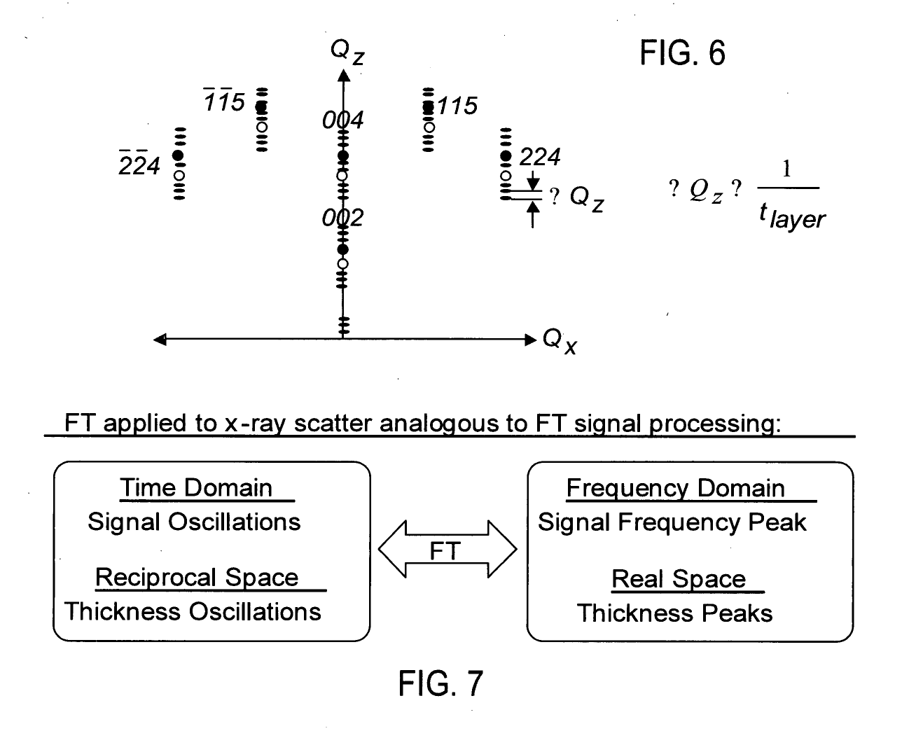

FIG. 6 is a reciprocal space schematic of one type of substrate having a layer on a surface thereof. FIG. 7 illustrates the analogous relationship between the time and frequency domains in a standard Fourier transform, and the reciprocal and real space domains associated with x-ray scatter oscillations for a layer on a substrate.

This introduces the Fourier analysis. The fringes may be analyzed because they are periodic in this reciprocal space. The Fourier analysis is applied to take away the distance in frequency space. For example, given a sine wave that is received over radio waves, apply a Fourier transform, and obtain the frequency of the sine wave. By analogy from a sine wave in reciprocal space, a distance in real space may be obtained.

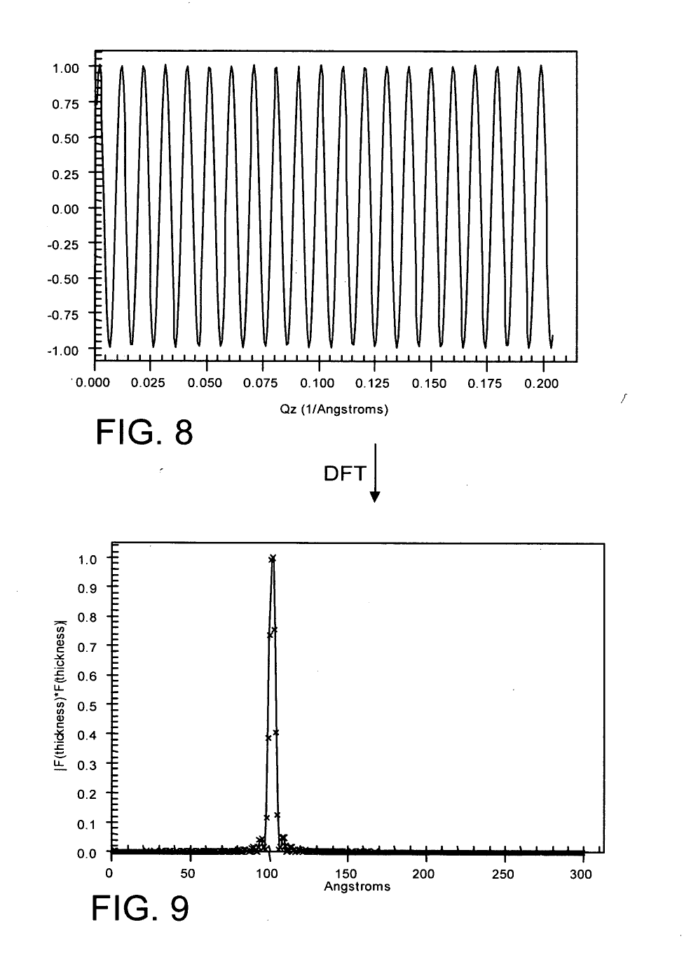

FIG. 8 depicts a sine wave and FIG. 9 depicts the results of taking a Fourier transform of the FIG. 8 wave. This is known for Fourier analysis. Taking a short sample of the same wave, the Fourier transform peak broadens out. This will show why Fourier transforms do not usually work on x-ray data.

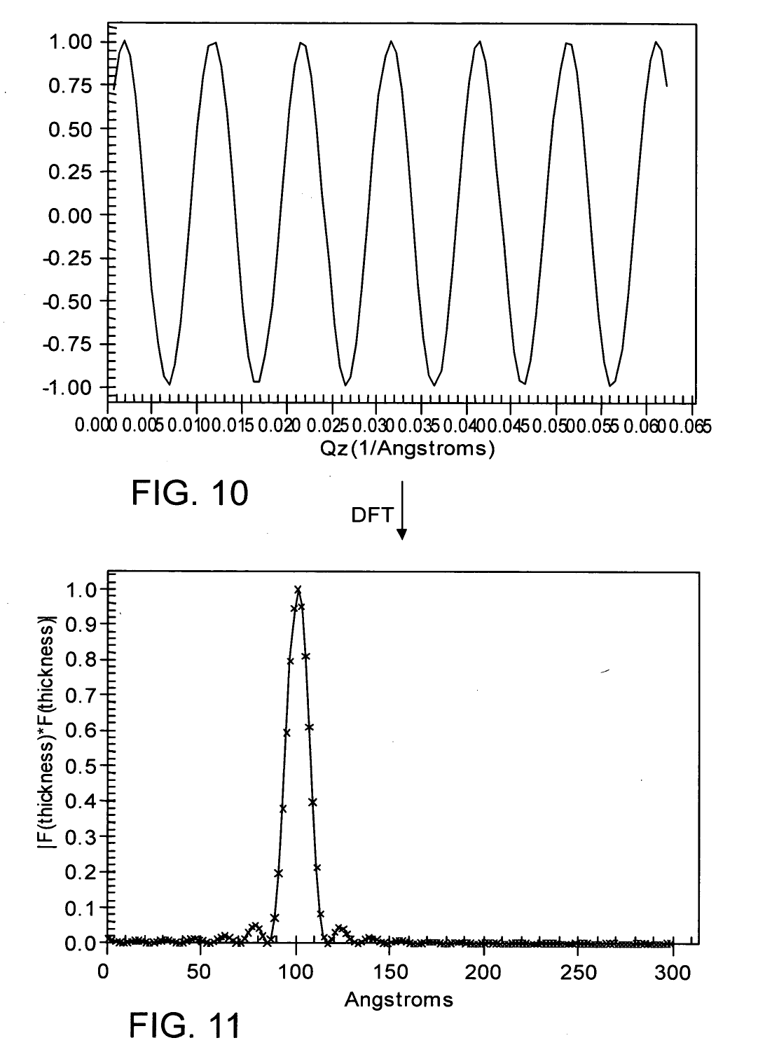

FIG. 10 depicts a truncated sine wave and FIG. 11 depicts the results of taking a Fourier transform of the FIG. 10 wave.

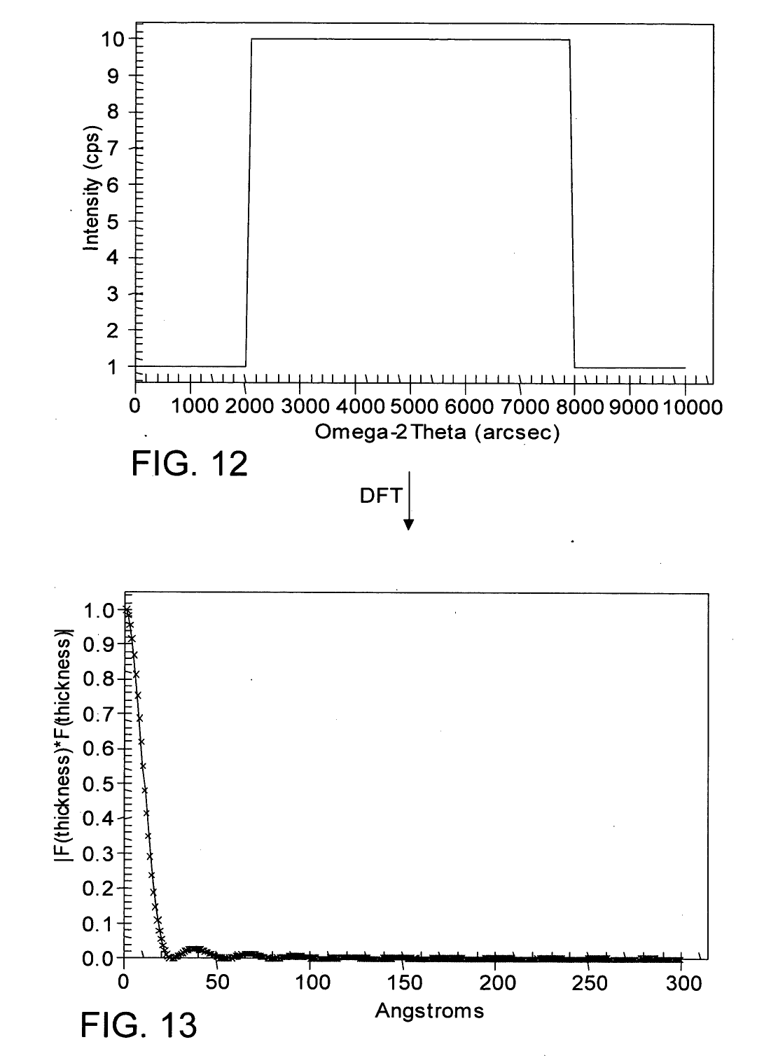

FIG. 12 depicts a square wave pulse and FIG. 13 depicts the results of taking a Fourier transform of the FIG. 12 wave. The Fourier transform of a square pulse is a sync function centered at zero in Fourier space. X-ray scatter typically yields short oscillations, which are essentially similar to a square pulse.

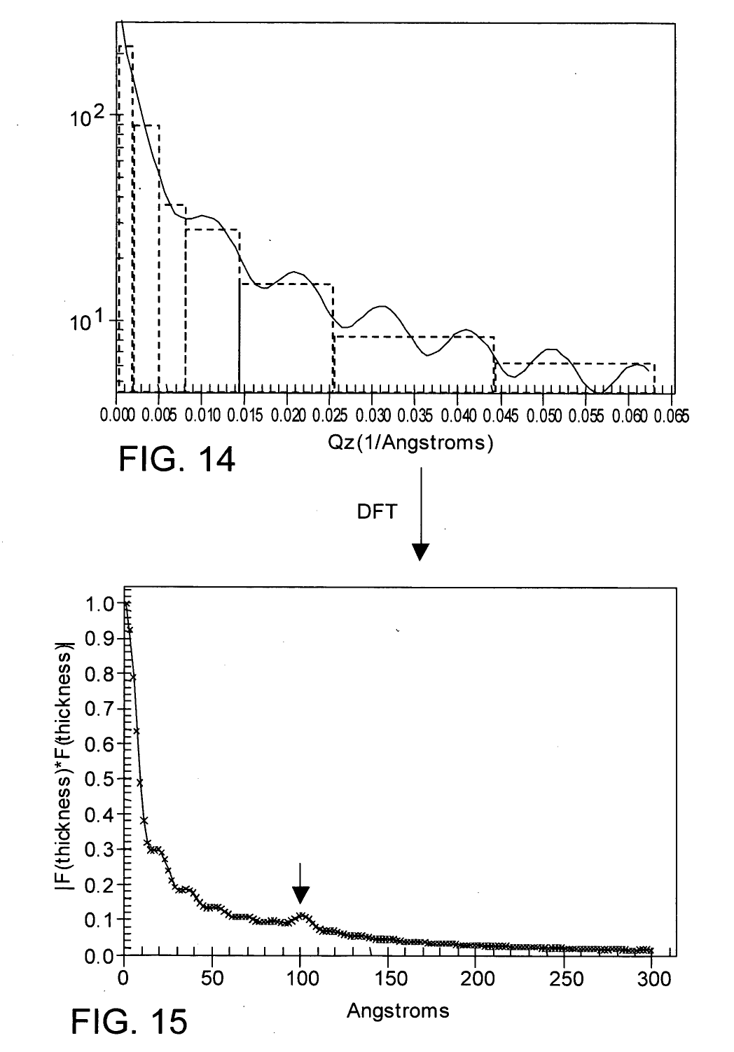

FIG. 14 depicts an offset sine wave illustrating the rough resemblance to a series of adjacent square pulses. FIG. 15 depicts the results of taking a Fourier transform of the FIG. 14 wave. The Fourier transform peak corresponding to the frequency of the sine wave is buried by the sync function associated with the square pulse effect. This will also show why Fourier transforms do not usually work on x-ray data.

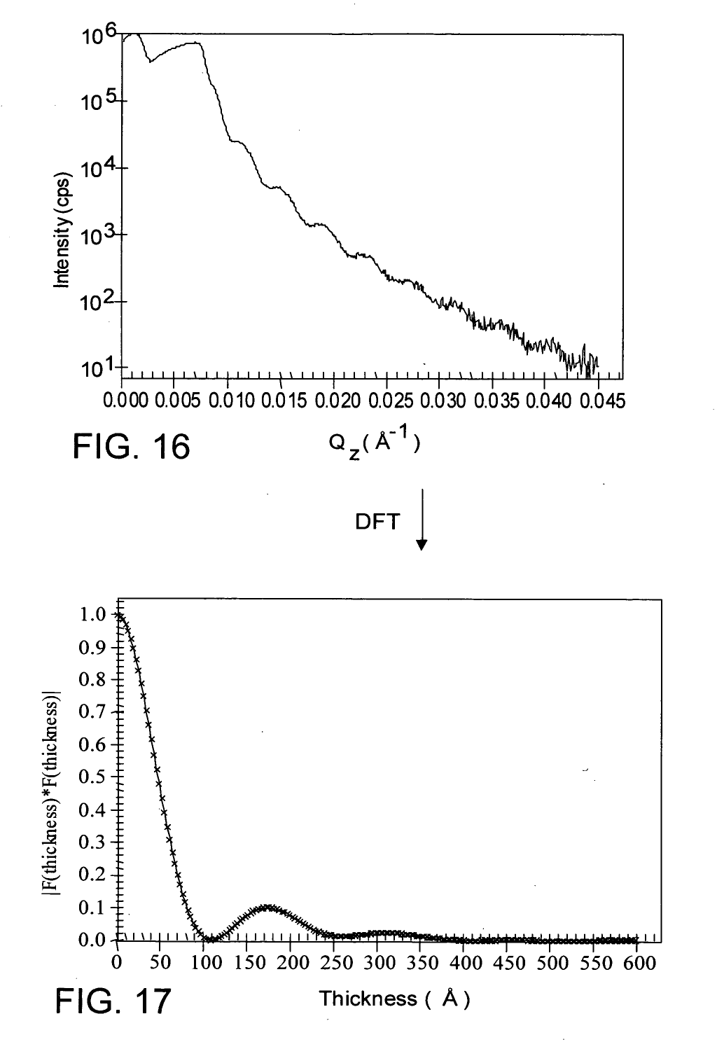

FIG. 16 is a graph of intensity versus reciprocal space coordinate, Q_{z}, of a layer on a substrate, and FIG. 17 depicts the results of taking a Fourier transform of the FIG. 16 wave.

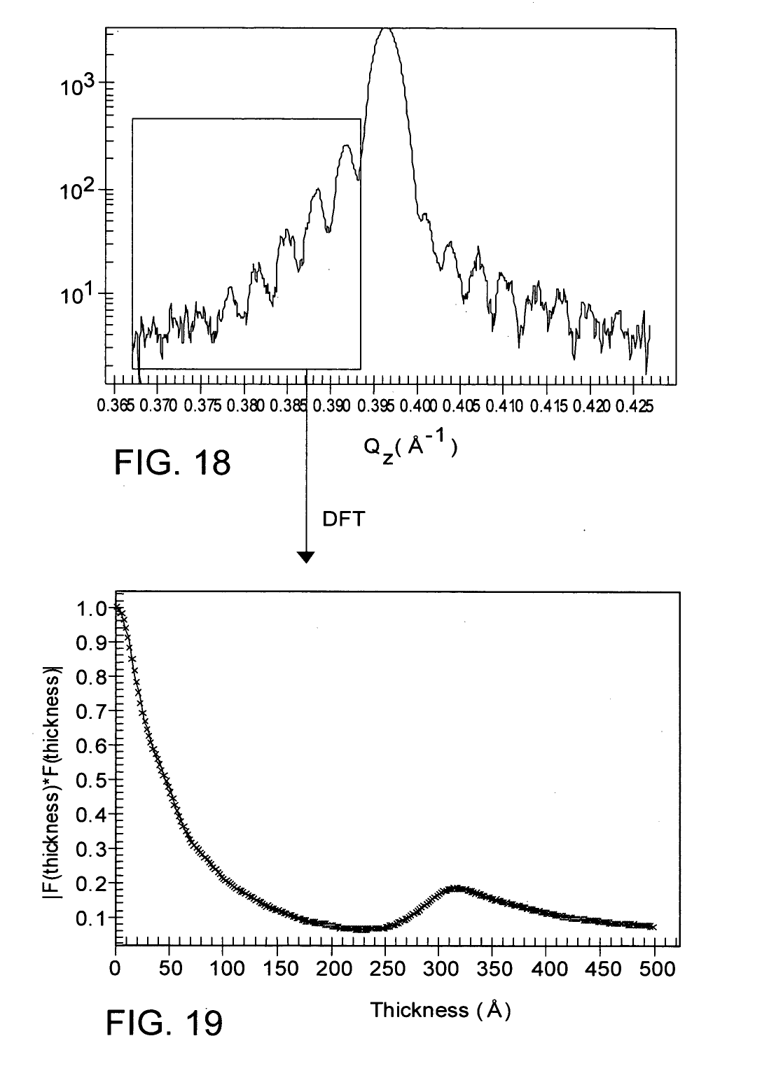

FIG. 18 is another graph of intensity versus Q_{z} of a layer on a substrate, and FIG. 19 depicts the results of taking a Fourier transform of the FIG. 18 wave

In embodiments of the present method and apparatus, the fringes are always on some type of offset slope. The Fourier transforms are typical. There is no correction for offset of the wave. There is typically no useful transform because the peaks are too broad and are not accurate. Because of the broad peaks there cannot be an accurate determination of the thickness to a desired degree. The square wave pulse effect is the root cause of the problem. One source of the square pulse effect is the fact that the wave is truncated and only about 8 fringes are sampled. An additional source of the square pulse effect is the offset of the truncated wave on a slope. This all combines to give a useless Fourier transform of raw data. Often the sought peak cannot be observed at all.

The above described problem has been previously addressed in several ways. Specular reflection is the radiation that is reflected from a surface at the same angle as the incident radiation. Off-specular is different angles for the incident and reflected radiations.

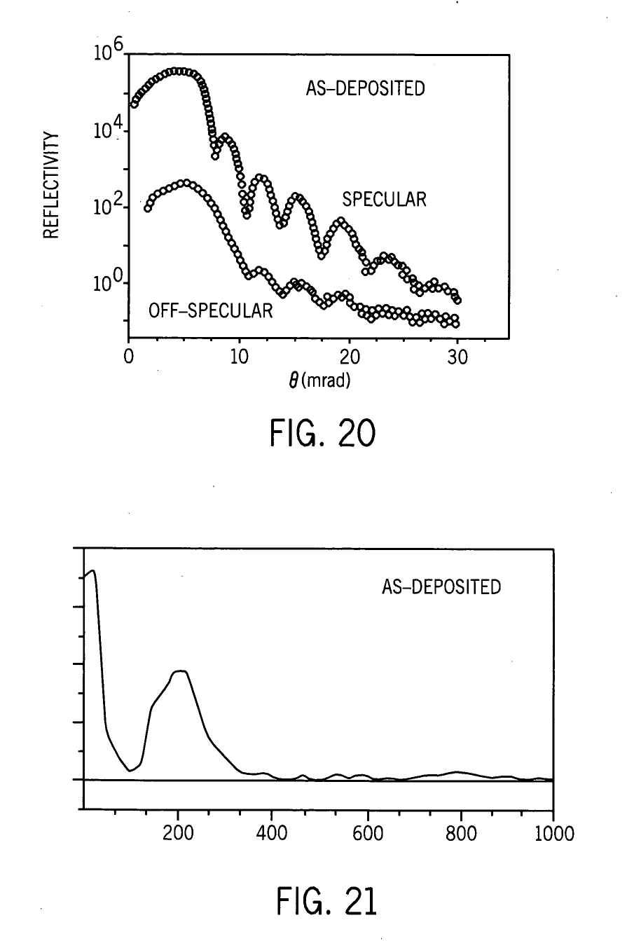

FIG. 20 is a graph depicting specular and off-specular scans, and FIG. 21 depicts the results of taking a fast Fourier transform of the specular scan following subtraction of the off-specular scan.

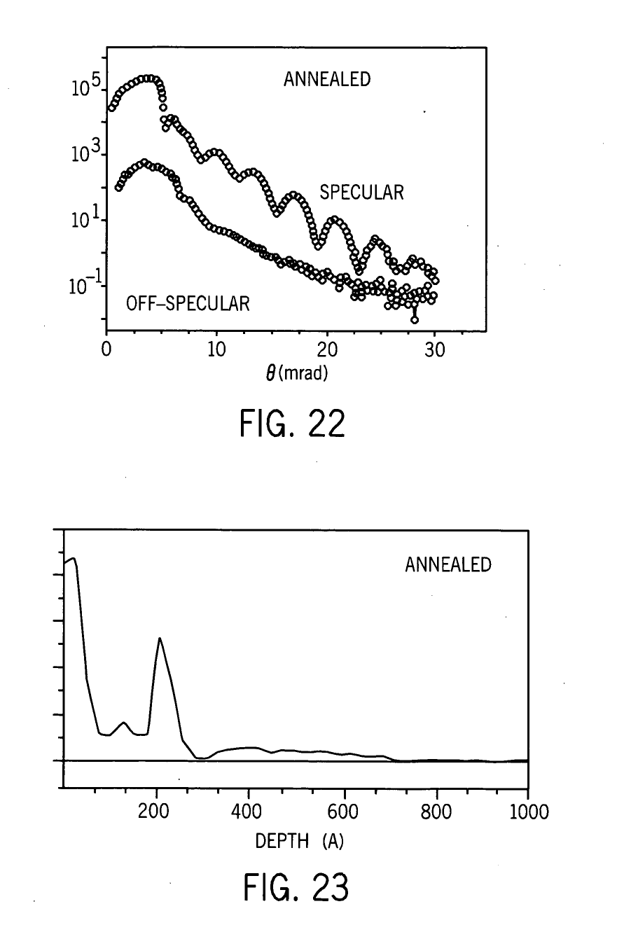

FIG. 22 is another graph depicting specular and off-specular scans, and FIG. 23 depicts the results of taking a fast Fourier transform of the difference thereof.

A known procedure is to measure specular and subtract off-specular in order to level out the data leaving only specular fringes, which attempts to eliminate the slope. The main disadvantage is that in the off-specular scan there are often fringes so that when they are subtracted from the main data, the main fringes that are to be viewed are weakened. This is a major problem.

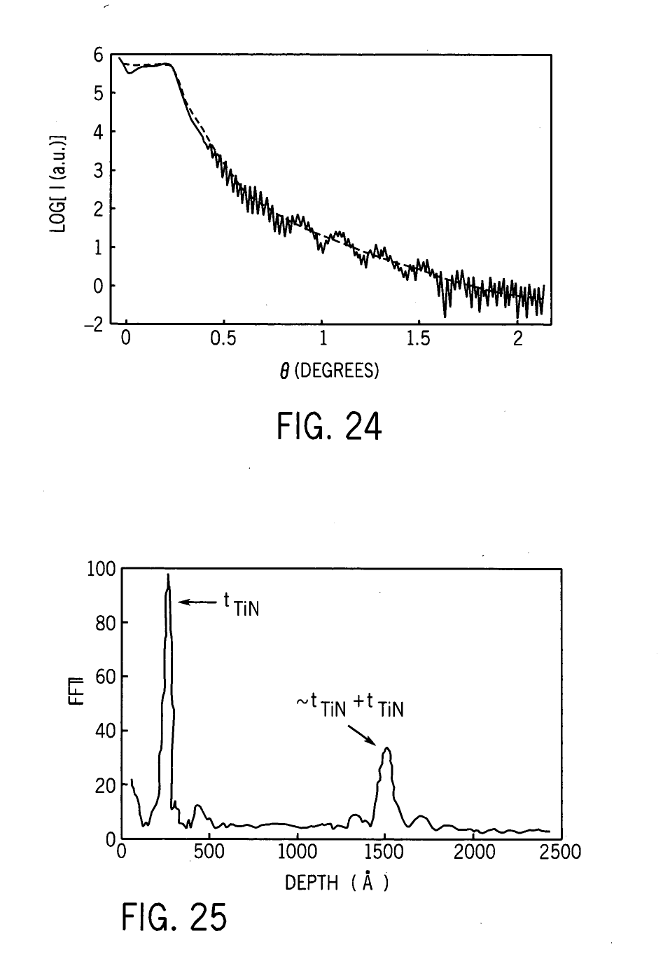

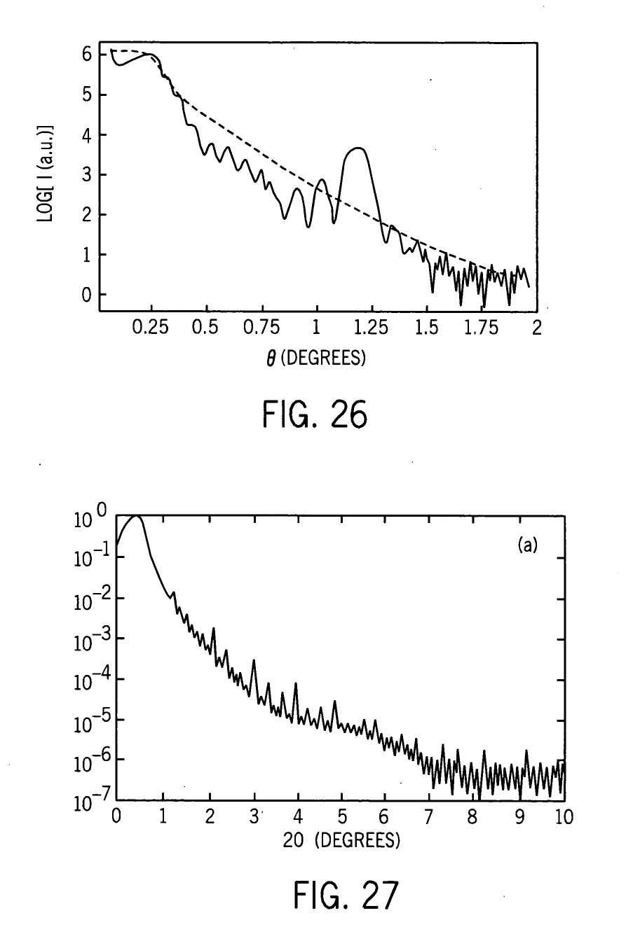

FIG. 24 is a graph depicting logarithmic compression and calculation of a semi-local intensity average, and FIG. 25 depicts the results of taking a fast Fourier transform thereof following subtraction of average. FIG. 26 is another graph depicting logarithmic compression and a calculated semi-local intensity average. In this prior art approach a heavy averaging is applied to the logarithmically compressed curve. The dash lines in FIG. 24 and FIG. 26 are the semi-local intensity averages of the curves. This average is subtracted from the data. This levels it out and leaves the oscillations there for the Fourier transforms. This works, however the angular range over which the semi-local intensity average is calculated must be chosen very carefully. Another disadvantage is that when the data does not have a smooth shape, subtraction of the semi-local average is ineffective. Sharp peaks, such as diffraction peaks, or small-angle reflectivity peaks associated with mesoscopic periodic structures such as super lattices can shift the average curve up in the vicinity of the peak, as seen in FIG. 26. When this data is leveled by subtracting the shifted curve it will still show a super lattice peak near 1.2 degrees. Additionally, areas of the curve in the vicinity of the peaks will have negative average intensity following subtraction of the elevated average, and the data will therefore still be sloped.

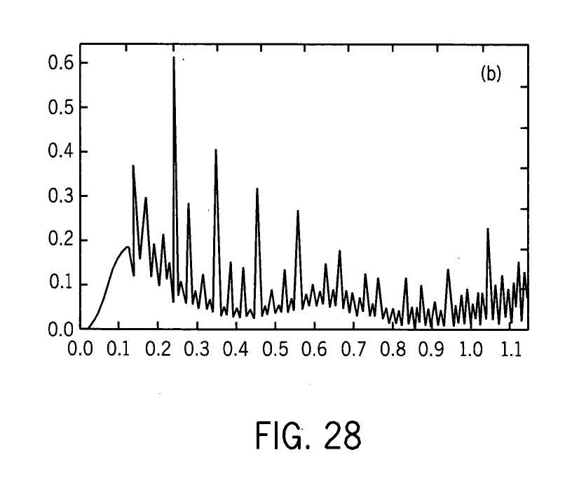

FIG. 27 is a graph of intensity versus two times the angle of incidence, and FIG. 28 is a graph of the intensity of FIG. 27 multiplied by Q_{z}⁴ versus Q_{z}⁴. When a reflectivity scan is performed, one is essentially looking at a Fourier transform of the series of interfaces that may be seen as layers are deposited on a substrate.

In the following equation, dρ(z)/dz is the derivative of the index of refraction as a function of z with respect to z, where z is a Cartesian coordinate normal to the surface of the substrate measured using x-ray reflectivity.

$$I ( {Q}_{z} ) \approx \frac{1}{{Q}_{z}^{4}} {\vert {FT}_{Q} ( \frac{d ρ ( z )}{d z} ) \vert}^{2}$$

Therefore, the layers are being traversed as one travels along z. A plot of the index of refraction versus z is flat going through a material of one composition and then there is a step when there is a layer of a different material. The point where there is a transition from one material to another material results in the derivative term hitting a peak. This applies for one to n layers.

The Fourier transform of the dρ(z)/dz curve yields an oscillation for each possible pair of derivative peaks. The 1/Q_{z}⁴ term describes the offset of the oscillations, or the sloping shape of the reflectivity scan. As the scattering angle increases so does the reciprocal space coordinate Q_{z}, and the reflected intensity drops off with Q_{z} raised to the 4^{th} power. Here, the Fourier term is not critical, it is the fact that 1/Q_{z}⁴ describes the sloping shape of the scan. Previously, all that was done was to multiply by 1/Q_{z}⁴ to level it back out. However, if the surface is rough the intensity falls off more rapidly with increasing Q_{z}, so multiplying by 1/Q_{z}⁴ will not level it effectively.

In embodiments according to the present method and apparatus the derivative is applied to level off a sloping set of data that is x-ray data.

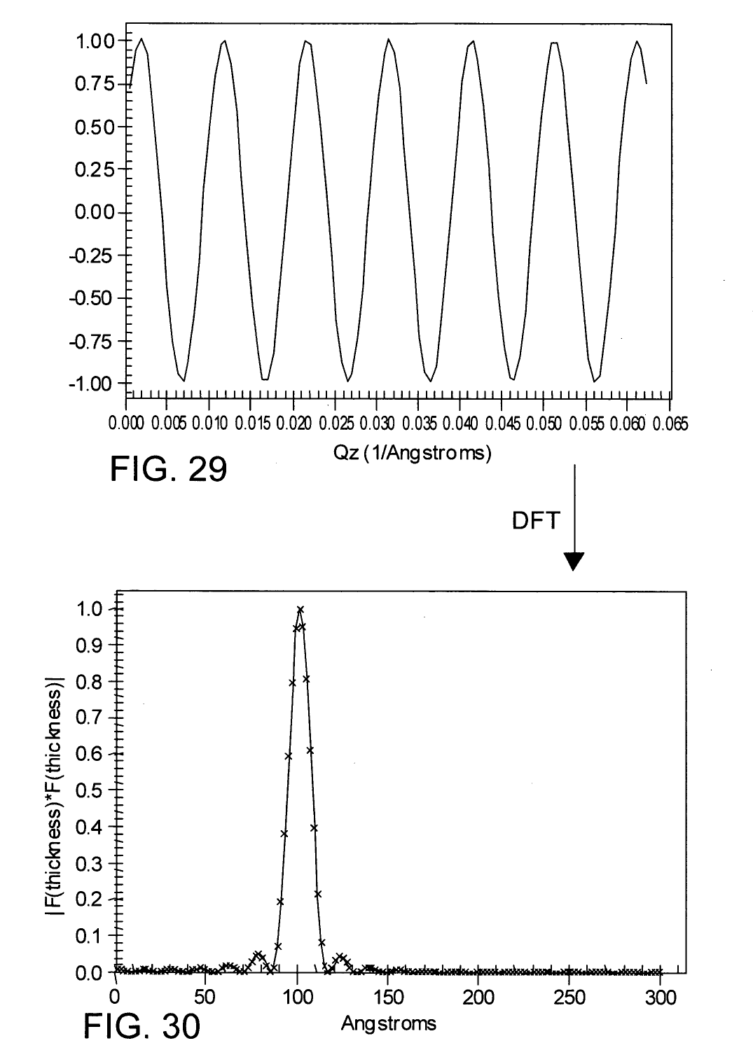

FIG. 29 depicts a sine wave and FIG. 30 depicts the results of taking a discrete Fourier transform of the FIG. 29 wave.

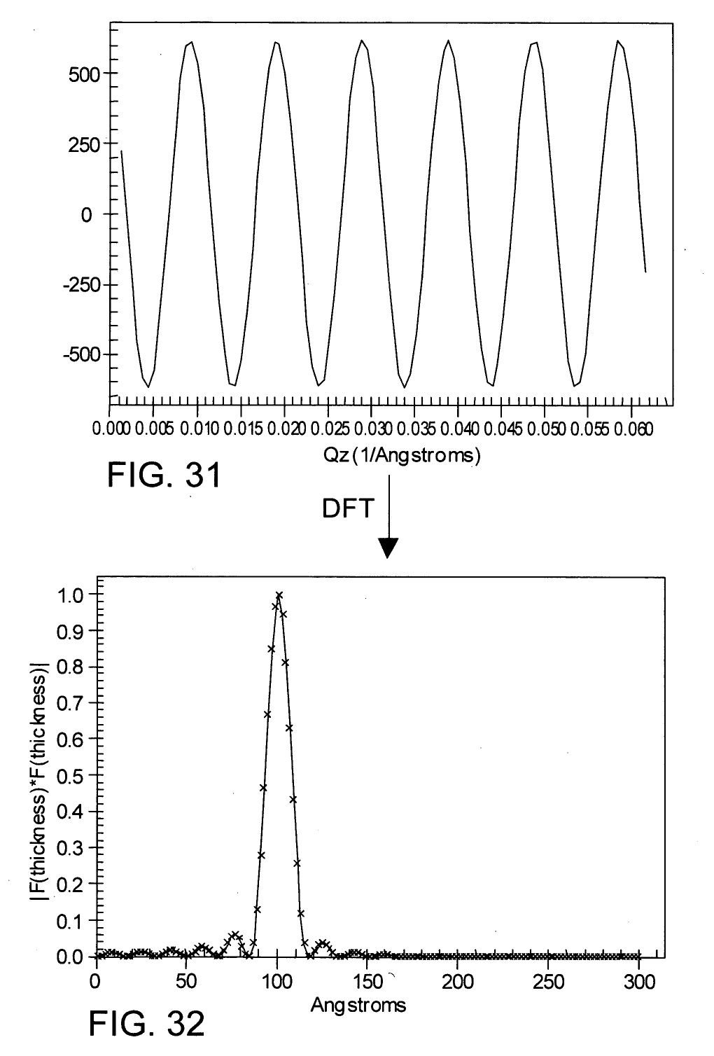

FIG. 31 depicts a derivative of the sine wave in FIG. 29 and FIG. 32 depicts the results of taking a discrete Fourier transform of the FIG. 31 wave.

The derivative of a sine curve gives a cosine curve, but it has the same phase. So when it is Fourier transformed the result is the same phase. There is no drawback to taking the derivative of the data because the frequency of oscillation in the data is not altered, and therefore neither is the position of the associated Fourier transform peak.

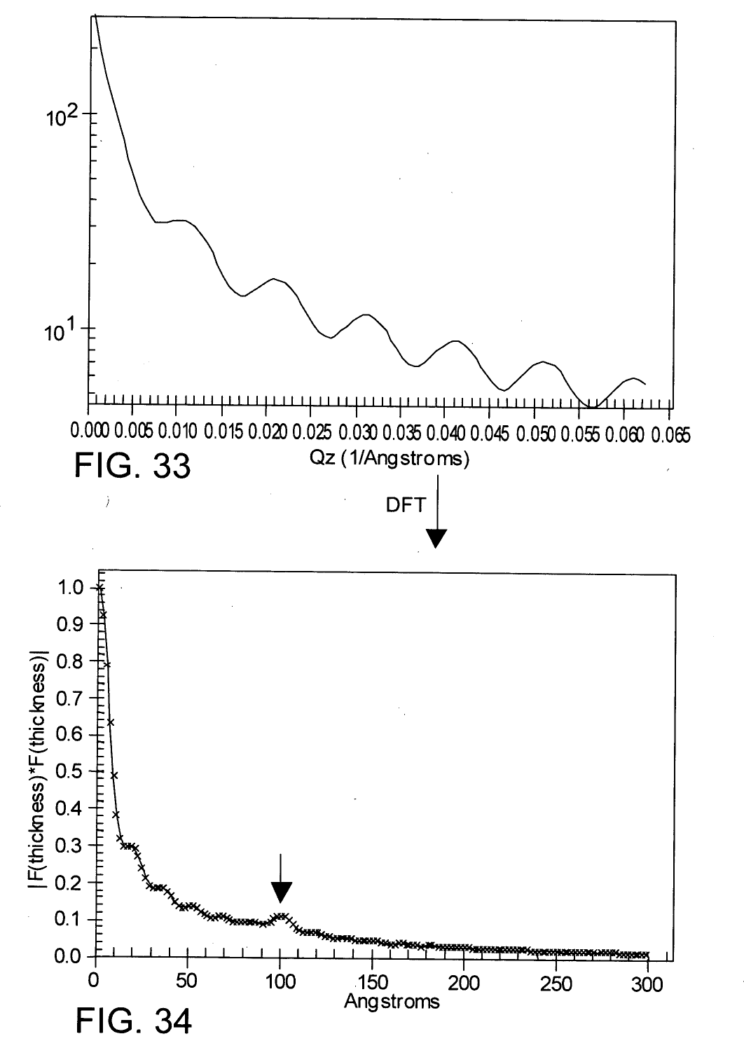

FIG. 33 depicts an offset sine wave and FIG. 34 depicts the results of taking a discrete Fourier transform of the FIG. 33 wave.

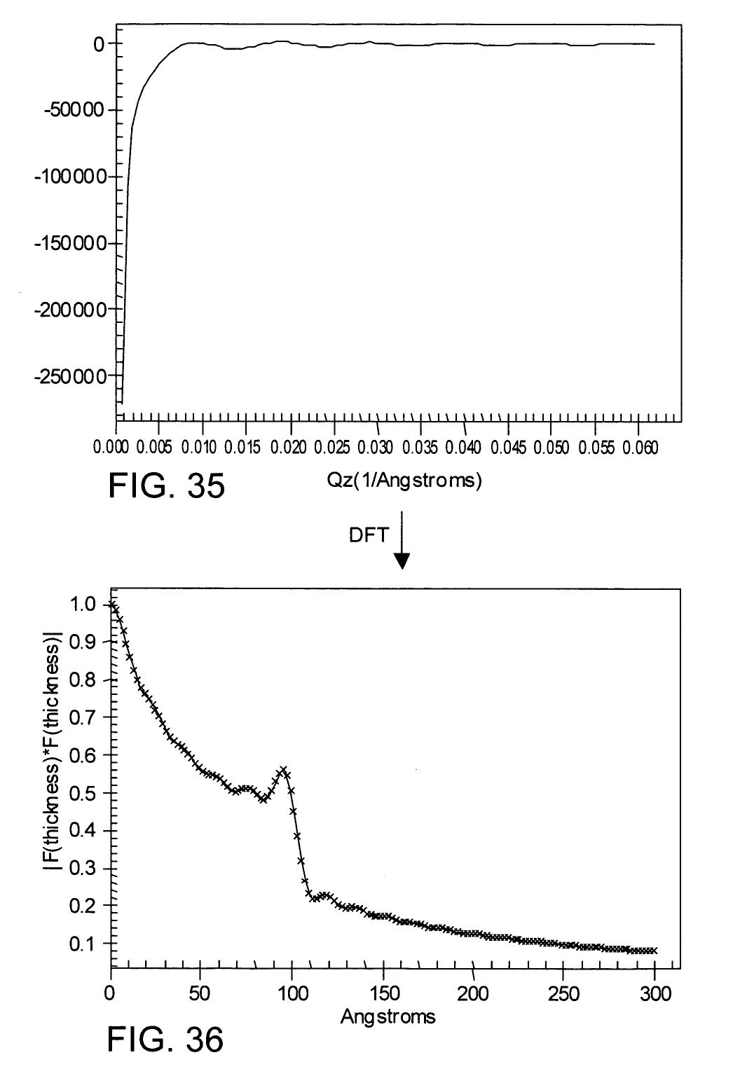

FIG. 35 depicts a derivative of the FIG. 33 offset sine wave and FIG. 36 depicts the results of taking a discrete Fourier transform of the FIG. 35 wave

The derivative may be taken of the offset sine wave, but at the lowest angle it is still not very level. However, the Fourier transform has still been improved due to suppression of the square pulse effect. Additional improvement is achieved when there is applied any kind of numeric compression (for example, taking the log, multiplying by Q_{z}⁴, taking the average, etc.) to the data as well as taking the derivative.

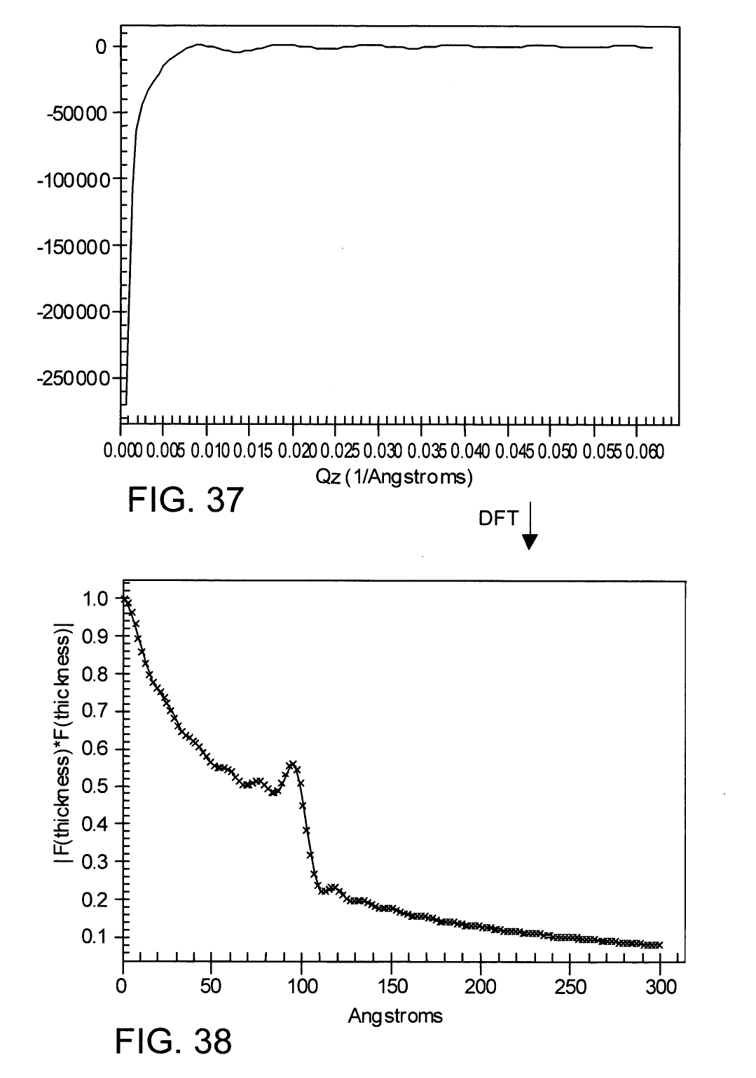

FIG. 37 depicts the derivative of a sloping sine wave and FIG. 38 depicts the results of taking a discrete Fourier transform of the FIG. 37 wave.

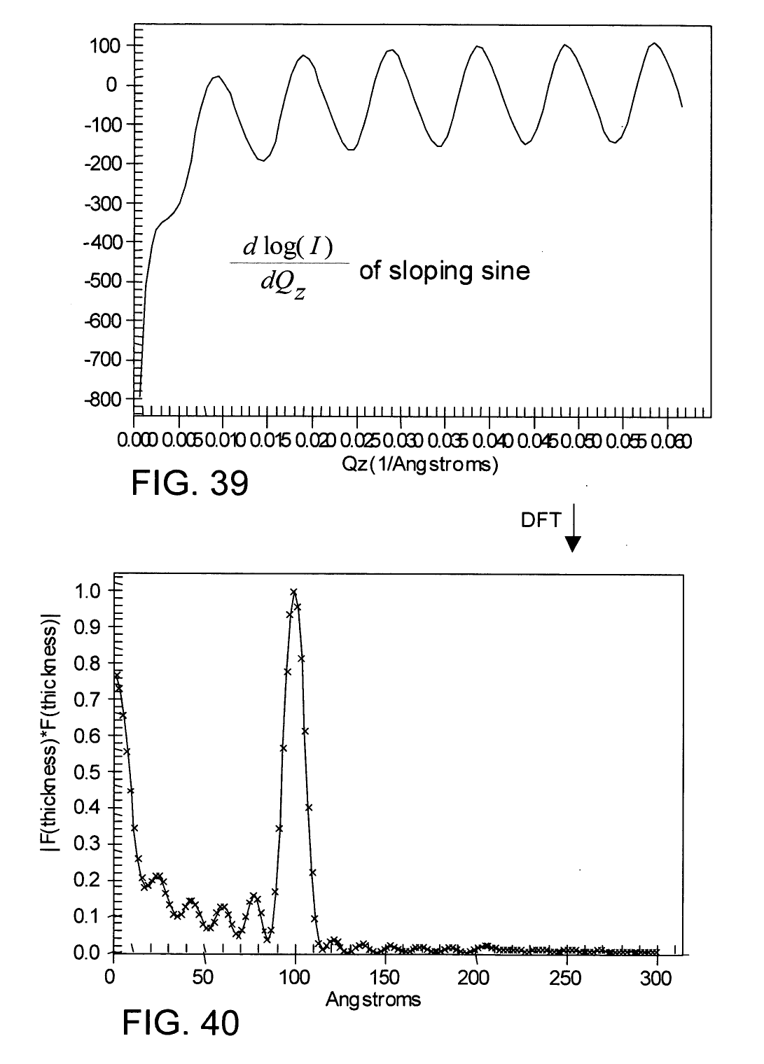

FIG. 39 depicts a derivative of the log of the FIG. 37 wave and FIG. 40 depicts the results of taking a discrete Fourier transform of the FIG. 39 wave.

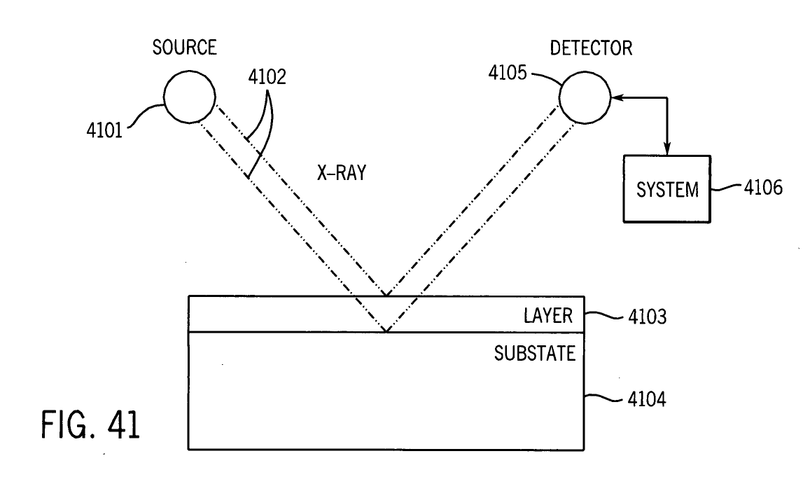

FIG. 41 depicts measurement of a layer 4103 on a substrate 4104 using X-rays 4102 according to an embodiment according to the present method and apparatus. The X-rays 4102 may be supplied by a source 4101 and scattering is detected by detector 4105. The detector 4105 may be operatively coupled to a system 4106 that analyzes the detected X-rays 4102 and determines the thickness of the layer 4103.

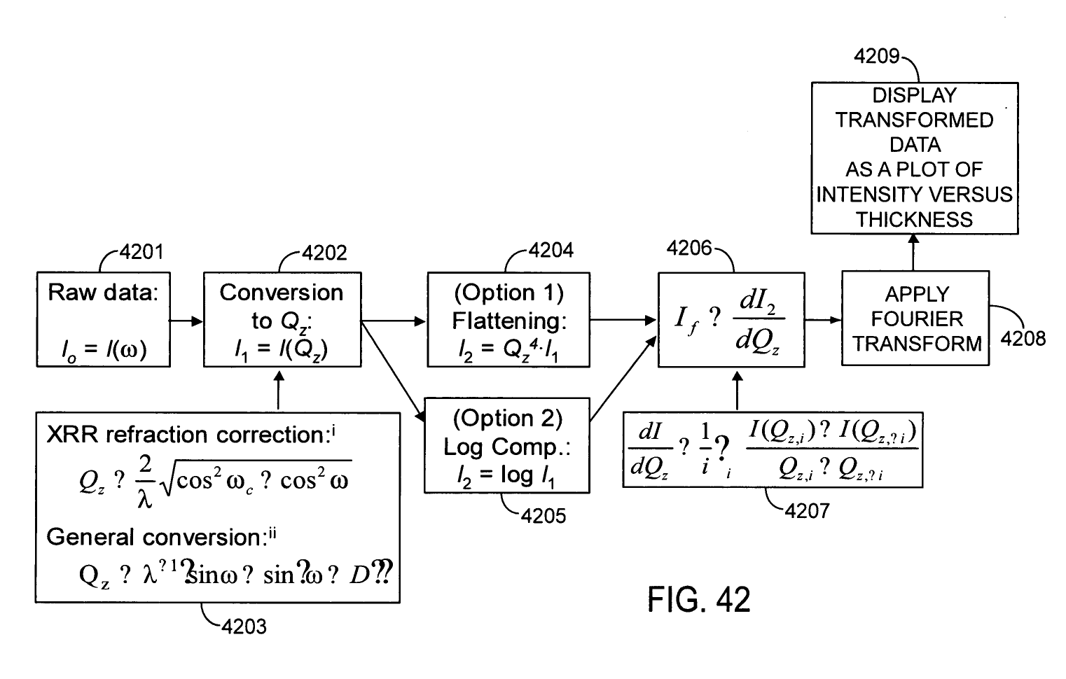

FIG. 42 depicts an embodiment according to the present method and apparatus in which the thickness of a layer may be determined. The process depicted in FIG. 42 may be implemented by one or more software modules, for example. In the depicted process raw x-ray scatter data 4201 is converted from intensity as a function of the scattering angle to intensity as a function of the surface normal reciprocal space coordinate Q_{z}, yielding x-ray scatter data 4202. This may be accomplished via different processes such as shown in 4203. The data is then flattened using one of a number of different processes such as processes 4204 and 4205. A first derivative is then taken of the flattened data at 4206, which may be accomplished using a process such as 4207. This produces derivate data. At 4208 a Fourier transform is performed on the derivate data. At 4209 the transformed data is displayed as a plot of intensity versus thickness for one or more layers on the substrate.

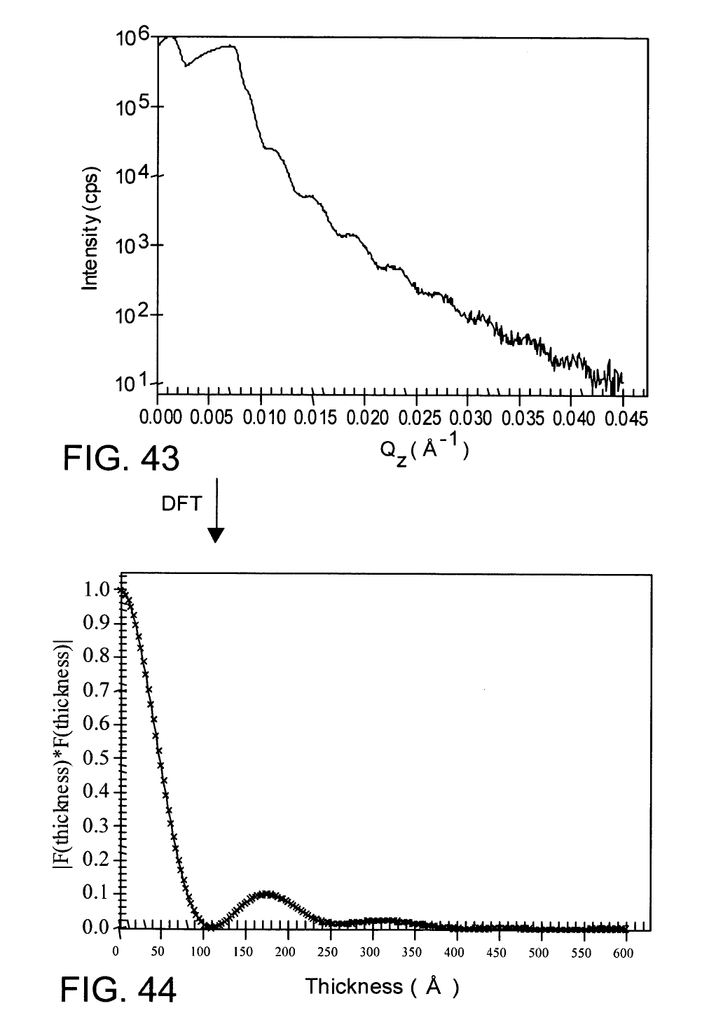

FIG. 43 depicts a conversion of raw x-ray scatter data to intensity versus Q_{z}, and FIG. 44 depicts the results of taking a discrete Fourier transform of the FIG. 43 wave.

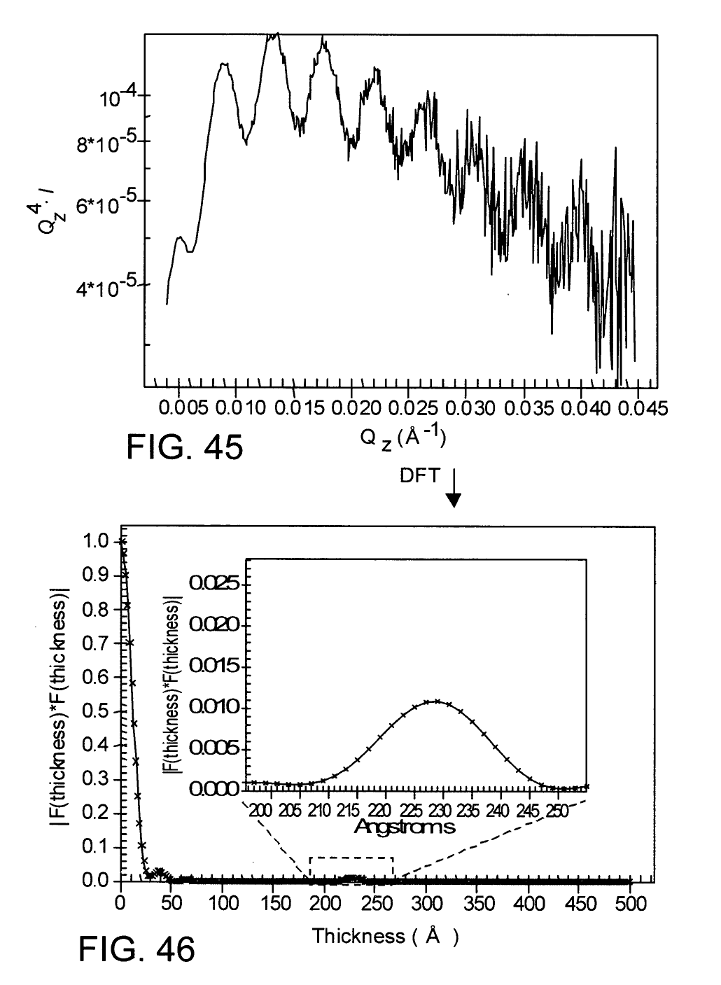

FIG. 45 depicts a flattening of the data through multiplication by Q_{z}⁴, and FIG. 46 depicts the results of taking a discrete Fourier transform of the FIG. 45 wave.

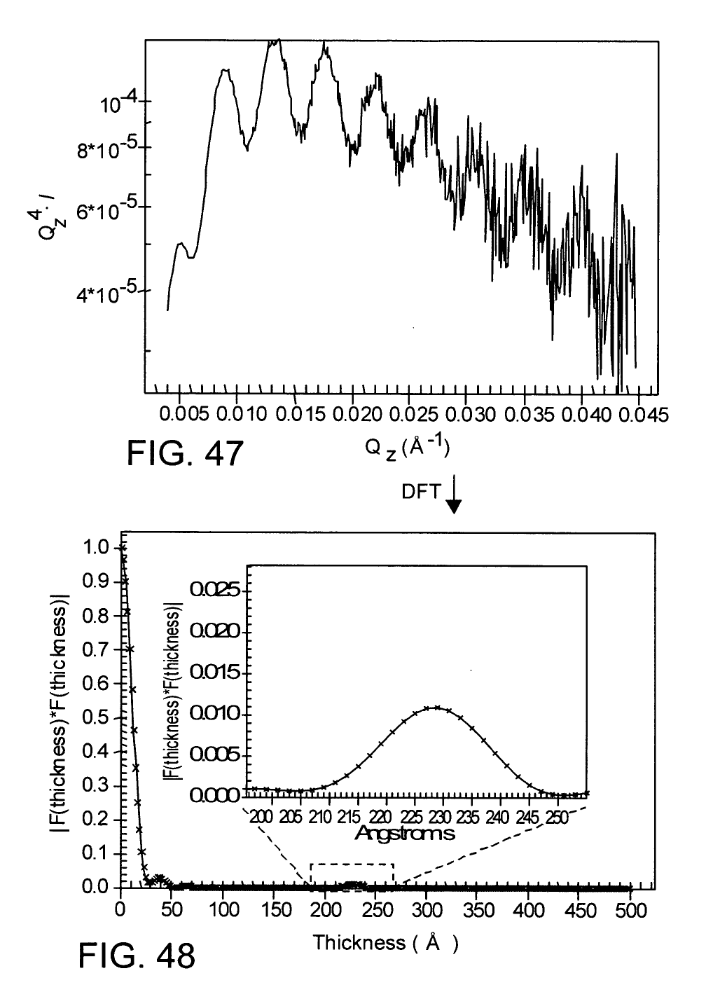

FIG. 47 depicts another flattening of the data through multiplication by Q_{z}⁴, and FIG. 48 depicts the results of taking a discrete Fourier transform of the FIG. 47 wave.

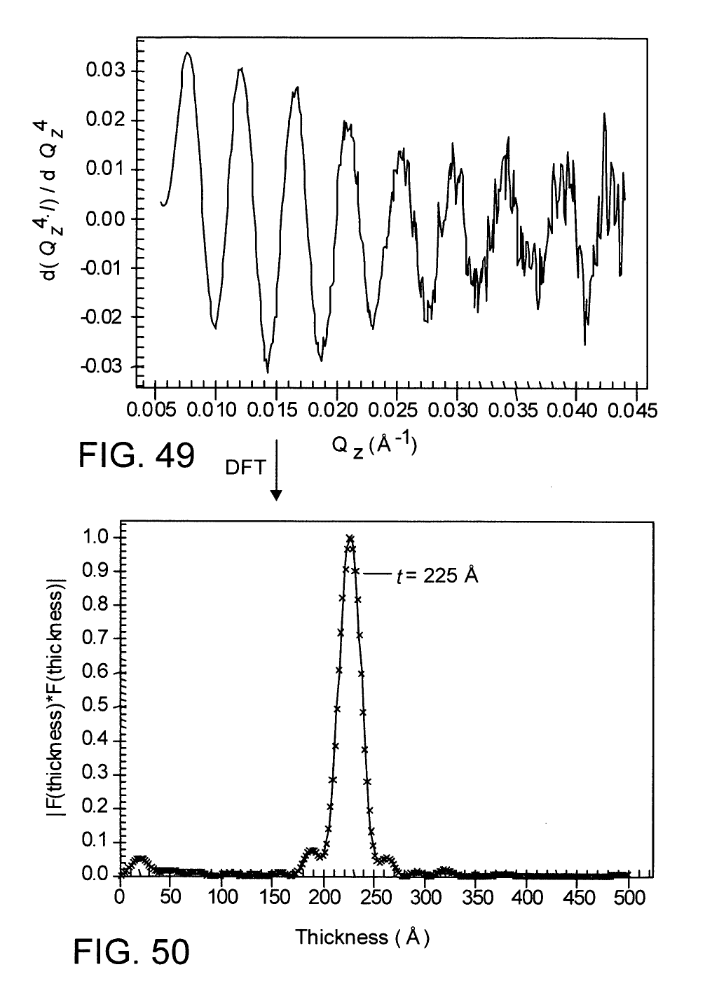

FIG. 49 depicts the result of taking the first derivative of the FIG. 47 curve, and FIG. 50 depicts the results of taking a discrete Fourier transform of the FIG. 49 wave.

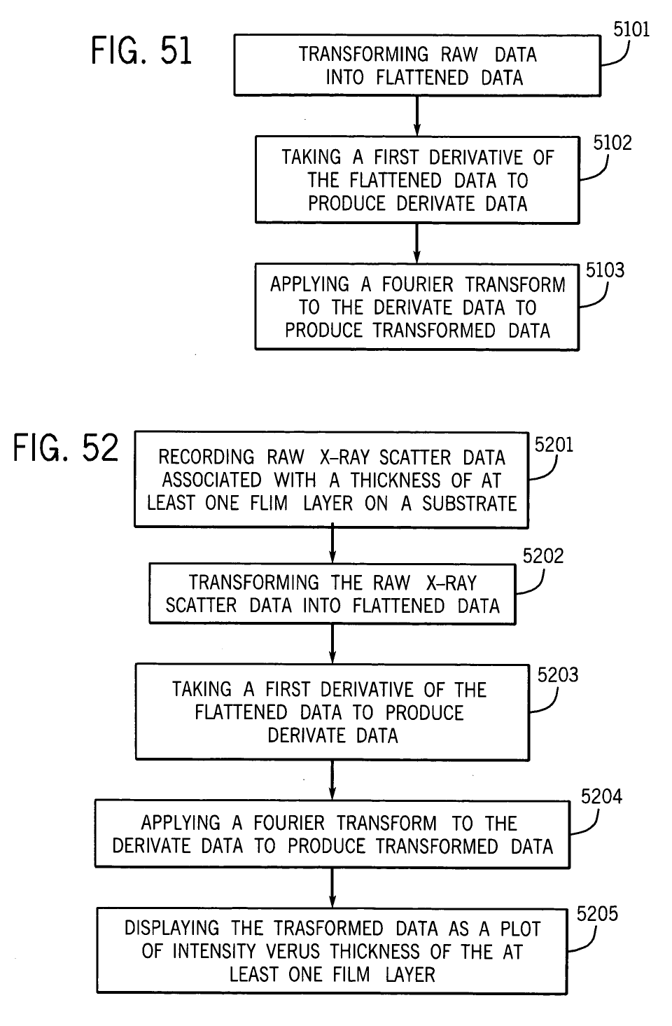

FIG. 51 depicts a method embodiment according to the present method and apparatus. In this embodiment the method may have the steps of: transforming raw data into flattened data (5101); taking a first derivative of the flattened data to produce derivate data (5102); and applying a Fourier transform to the derivate data to produce transformed data (5103).

FIG. 52 depicts another method embodiment according to the present method and apparatus. In this embodiment the method may have the steps of: recording raw x-ray scatter data associated with a thickness of at least one film layer on a substrate (5201); transforming the raw x-ray scatter data into flattened data (5202); taking a first derivative of the flattened data to produce derivate data (5203); applying a Fourier transform to the derivate data to produce transformed data (5204); and displaying the transformed data as a plot of intensity versus thickness of the at least one film layer (5205).

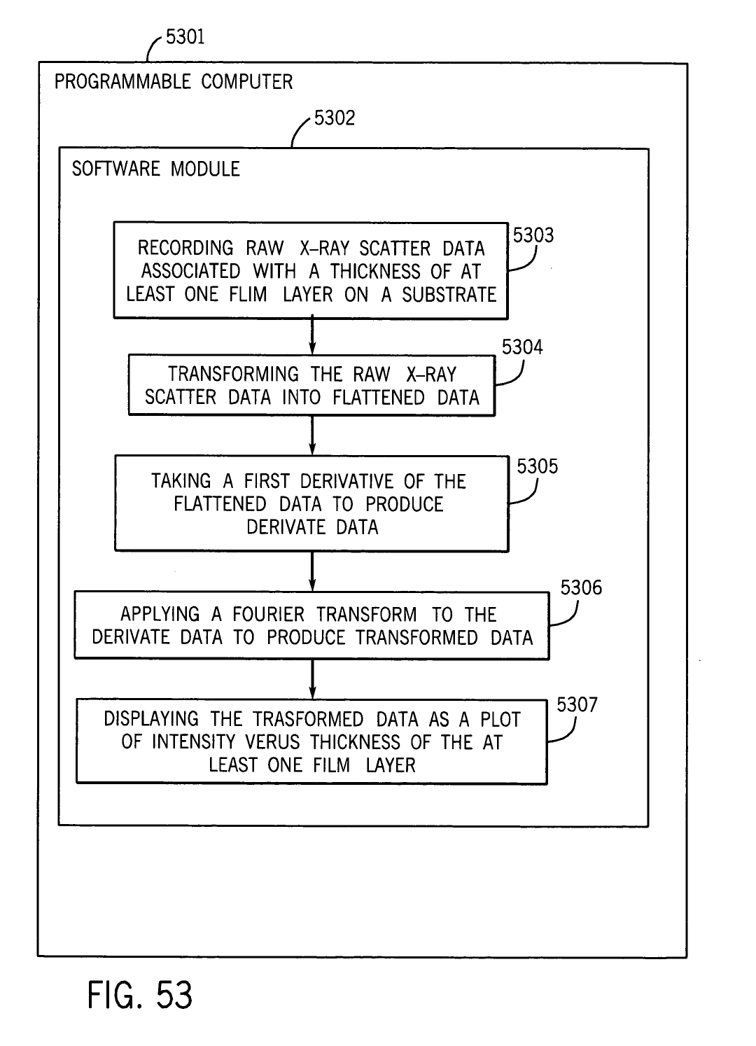

FIG. 53 depicts a software embodiment according to the present method and apparatus. In this embodiment the present method and apparatus are implemented in a programmable computer (5301) having at least one software module (5302) having: means for recording raw x-ray scatter data associated with a thickness of at least one film layer on a substrate (5303); means for transforming the raw x-ray scatter data into flattened data (5304); means for taking a first derivative of the flattened data to produce derivate data (5305); means for applying a Fourier transform to the derivate data to produce transformed data (5306); and means for displaying the transformed data as a plot of intensity versus thickness of the at least one film layer (5307). Other embodiments may utilize a plurality of software modules.

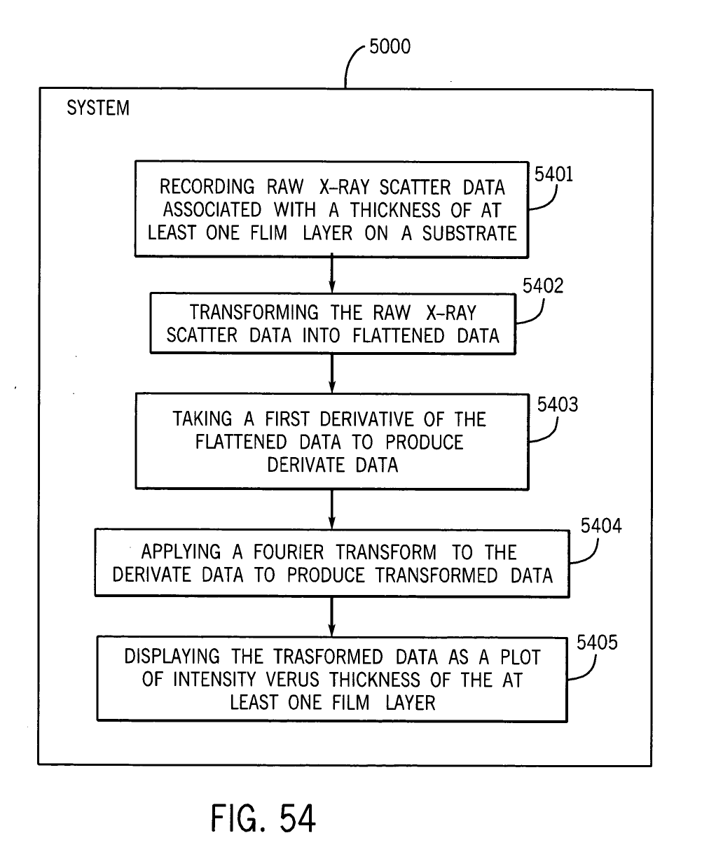

FIG. 54 depicts a system embodiment according to the present method and apparatus. In this embodiment the present method and apparatus are implemented in a system (5400) having: means for recording raw x-ray scatter data associated with a thickness of at least one film layer on a substrate (5401); means for transforming the raw x-ray scatter data into flattened data that is a sloping set of data (5402); means for applying a derivative to level off the sloping set of data to produce derivate data (5403); means for applying a Fourier transform to the derivate data to produce transformed data (5404); and means for displaying the transformed data as a plot of intensity versus thickness of the at least one film layer (5405).

The present apparatus in one example may comprise a plurality of components such as one or more of electronic components, hardware components, and computer software components. A number of such components may be combined or divided in the apparatus.

The present apparatus may employ at least one computer-readable signal-bearing media that may store software, firmware and/or assembly language, etc. The computer-readable signal-bearing medium may comprise magnetic, electrical, optical, biological, and/or atomic data storage mediums. For example, the computer-readable signal-bearing medium may comprise floppy disks, magnetic tapes, CD-ROMs, DVD-ROMs, hard disk drives, and electronic memories, etc. The computer-readable signal-bearing medium may also comprise a modulated carrier signal transmitted over a network comprising or coupled with the apparatus, for instance, at least one of a telephone network, a local area network (“LAN”), a wide area network (“WAN”), the Internet, and a wireless network.

The present method and apparatus are not limited to the particular details of the depicted embodiments and other modifications and applications are contemplated. Certain other changes may be made in the above-described embodiments without departing from the true spirit and scope of the present method and apparatus herein involved. It is intended, therefore, that the subject matter in the above depiction shall be interpreted as illustrative and not in a limiting sense.

We claim:

1. A method comprising:
transforming raw data into flattened data;
taking a first derivative of the flattened data to produce derivate data; and
applying a Fourier transform to the derivate data to produce transformed data.

2. The method according to claim 1, wherein the method further comprises:
recording x-ray scatter data associated with a thickness of at least one film layer on a substrate, the x-ray scatter data being the raw data; and
displaying the transformed data as a plot of intensity versus thickness of the at least one film layer.

3. The method according to claim 1, wherein the method further comprises:
recording x-ray scatter data associated with respective thicknesses of a plurality of film layers on a substrate, the x-ray scatter data being the raw data; and
displaying the transformed data as respective plots of intensity versus thickness of the plurality of film layers.

4. The method according to claim 1, wherein the method further comprises converting the raw data to converted raw data with a predetermined conversion function, the raw data being in the form of intensity as a function of angle, and the converted raw data being in the form of intensity as a function of reciprocal space coordinate.

5. The method according to claim 4, wherein the method further comprises flattening the converted raw data with a predetermined flattening function.

6. A method comprising:
recording raw x-ray scatter data associated with a thickness of at least one film layer on a substrate;
transforming the raw x-ray scatter data into flattened data;
taking a first derivative of the flattened data to produce derivate data;
applying a Fourier transform to the derivate data to produce transformed data; and
displaying the transformed data as a plot of intensity versus thickness of the at least one film layer.

7. The method according to claim 6, wherein the method further comprises:
recording x-ray scatter data associated with respective thicknesses of a plurality of film layers on a substrate, the x-ray scatter data being the raw data; and
displaying the transformed data as respective plots of intensity versus thickness of the plurality of film layers.

8. The method according to claim 6, wherein the method further comprises converting the raw data to converted raw data with a predetermined conversion function, the raw data being in the form of intensity as a function of angle, and the converted raw data being in the form of intensity as a function of reciprocal space coordinate.

9. The method according to claim 8, wherein the method further comprises flattening the converted raw data with a predetermined flattening function.

10. A programmable computer comprising:
a record module for recording raw x-ray scatter data associated with a thickness of at least one film layer on a substrate;
a transform module for transforming the raw x-ray scatter data into flattened data;
a derivative module for taking a first derivative of the flattened data to produce derivate data;
a Fourier module for applying a Fourier transform to the derivate data to produce transformed data; and
a display module for displaying the transformed data as a plot of intensity versus thickness of the at least one film layer.

11. The programmable computer according to claim 10, wherein the programmable computer further comprises:
a converter module for converting the raw x-ray scatter data to converted raw x-ray scatter data with a predetermined conversion function, the raw x-ray scatter data being in the form of intensity as a function of angle, and the converted raw x-ray scatter data being in the form of intensity as a function of reciprocal space coordinate.

12. The programmable computer according to claim 11, wherein the programmable computer further comprises:
a flattening module for flattening the converted raw data with a predetermined flattening function.

13. The programmable computer according to claim 10, wherein the raw x-ray scatter data is associated with respective thicknesses of a plurality of film layers on a substrate, and wherein the transformed data is representative of respective thicknesses of the plurality of film layers.

14. A computer storage medium containing at least one software module for performing the steps of:
recording raw x-ray scatter data associated with a thickness of at least one film layer on a substrate;
transforming the raw x-ray scatter data into flattened data;
taking a first derivative of the flattened data to produce derivate data;
applying a Fourier transform to the derivate data to produce transformed data; and
displaying the transformed data as a plot of intensity versus thickness of the at least one film layer.

15. The computer storage medium to claim 14, wherein the at least one software module further performs the step of:
converting the raw x-ray scatter data to converted raw x-ray scatter data with a predetermined conversion function, the raw x-ray scatter data being in the form of intensity as a function of angle, and the converted raw x-ray scatter data being in the form of intensity as a function of reciprocal space coordinate.

16. The computer storage medium to claim 14, wherein the at least one software module further performs the step of:
flattening the converted raw data with a predetermined flattening function.

17. The computer storage medium to claim 14, wherein the raw x-ray scatter data is associated with respective thicknesses of a plurality of film layers on a substrate, and wherein the transformed data is representative of respective thicknesses of the plurality of film layers.

18. A system comprising:
a recorder module for recording raw x-ray scatter data associated with a thickness of at least one film layer on a substrate;
a transform module for transforming the raw x-ray scatter data into flattened data that is a sloping set of data, the transform module operatively coupled to the recorder module;
a derivative module for applying a derivative to level off the sloping set of data to produce derivate data, the derivative module operatively coupled to the transform module;
a Fourier module for applying a Fourier transform to the derivate data to produce transformed data, the Fourier module operatively coupled to the derivative module; and
a display module for displaying the transformed data as a plot of intensity versus thickness of the at least one film layer, the display module operatively coupled to the Fourier module.

19. The system according to claim 18, wherein the system further comprises:
a converter module for converting the raw x-ray scatter data to converted raw x-ray scatter data with a predetermined conversion function, the raw x-ray scatter data being in the form of intensity as a function of angle, and the converted raw x-ray scatter data being in the form of intensity as a function of reciprocal space coordinate, the converter module operatively coupled between the recorder module and the transform module.

20. The system according to claim 19, wherein the transform module further comprises:
a flattening module for flattening the converted raw data with a predetermined flattening function.

21. The system according to claim 18, wherein the raw x-ray scatter data is associated with respective thicknesses of a plurality of film layers on a substrate, and wherein the transformed data is representative of respective thicknesses of the plurality of film layers.
